(19) United States
(12) Patent Application Publication
(10) Pub. No.: US 2021/0039609 A1
(43) Pub. Date: Feb. 11, 2021

(54) ICE-REMOVAL TOOL FOR AN ICE-REMOVAL MACHINE, AND HAND-HELD ICE-REMOVAL MACHINE

(71) Applicant: Alfred Kärcher SE & Co. KG, Winnenden (DE)

(72) Inventors: Anatoli Wangler, Lorch (DE); Felix Winter, Allmersbach im Tal (DE); Martin Baumhackl, Kirchberg/Murr (DE); Philip Ziegler, Leutenbach (DE)

(21) Appl. No.: 17/084,001

(22) Filed: Oct. 29, 2020

Related U.S. Application Data
(63) Continuation of application No. PCT/EP2018/061040, filed on Apr. 30, 2018.

(51) Int. Cl. B60S 3/04; B08B 1/00; B08B 1/04

(52) U.S. Cl. CPC B60S 3/048; B08B 1/04; B08B 1/005

(57) ABSTRACT

An ice-removal tool for an ice-removal machine is provided, which tool, during operation, is driven in rotation about an axis of rotation, including a disc-shaped holder with a first side and a second side, which is opposite the first side, wherein a plurality of ridges is arranged on the first side, wherein a toothed ring with an inner toothing is arranged on the second side.

### CROSS-REFERENCE TO RELATED APPLICATIONS

This application is a continuation of international application number PCT/EP2018/061040 filed on Apr. 30, 2018, which is incorporated herein by reference in its entirety and for all purposes.

### BACKGROUND OF THE INVENTION

The invention relates to an ice-removal tool for an ice-removal machine, which tool, during operation, is driven in rotation about an axis of rotation, comprising a disc-shaped holder with a first side and a second side, which is opposite the first side, wherein a plurality of ridges is arranged on the first side.

The invention also relates to a hand-held ice-removal machine.

An ice-removal machine is described in CN 101336816 B.

In accordance with an embodiment of the invention, an ice-removal tool of the type described at the outset is provided with which ice can be removed effectively.

### SUMMARY OF THE INVENTION

In accordance with an embodiment of the invention, provision is made for a toothed ring with an inner toothing to be arranged on the second side.

The ice-removal tool in accordance with the invention can be used with an ice-removal machine and in particular with a hand-held ice-removal machine. It thus makes it possible to mechanically remove in particular ice from a vehicle window easily.

The toothed ring with an inner toothing on the second side of the holder allows the ice-removal tool to be configured as a type of ring gear for an epicyclic gearing. This allows the ice-removal tool to be easily integrated into an ice-removal machine, which can be configured with small dimensions and in particular height dimensions. This makes it possible to achieve an ergonomically advantageous operability.

An epicyclic gearing with a ring gear (the toothed ring with the inner toothing forms this ring gear) can be realized with low axial height. This, in turn, allows the realization of an ice-removal machine that has a held ice-removal tool and that is compact and easy to operate and in particular can be held by just one hand.

The ridges form a toothing which has an ice scraping effect.

It is advantageous in terms of construction if the ridges and/or the toothed ring are integrally connected to the holder. This allows the ice-removal tool to be produced in compact form in a simple way. In particular, it can be made of a plastics material such as ABS. For example, it may also be provided that the ridges are separate elements from the holder, which are fixed to the holder, for example, by T-slots.

It is very particularly advantageous if a first ring is arranged on the second side, is spaced from the toothed ring, and surrounds the toothed ring, in particular the first ring being integrally connected to the holder. The first ring can be used to provide additional support and in particular sliding support on the ice-removal machine. Alternatively or additionally, a type of labyrinth seal can be formed which prevents fluids from entering the ice-removal machine when the ice-removal tool is mounted.

For example, the first ring has a smaller height above the holder than the toothed ring.

This results in a simple structural construction.

It may also be favorable if a second ring is arranged on the second side, is spaced from the first ring, and surrounds the first ring, in particular the second ring being integrally connected to the holder. In this way, a labyrinth seal can be easily formed and/or additional sliding bearing surfaces can be provided.

A structurally favorable construction is provided if the second ring has a lower height than the first ring and/or the toothed ring.

It is very particularly advantageous if the first ring or a second ring surrounding the first ring forms an edge and in particular a raised edge on the holder. In this way, a labyrinth seal can be easily formed. Furthermore, the penetration of fluid over the edge of the ice-removal tool into the ice-removal machine can be prevented or made more difficult.

In particular, at least one of the following is provided: at least one sliding surface is arranged on the first ring; a region on the holder between the first ring and the toothed ring forms a sliding surface; a second ring surrounding the first ring has at least one sliding surface; a region between the second ring and the first ring forms a sliding surface; the first ring and/or second ring form a fluid seal or part of a fluid seal. It is thus possible to provide sliding bearing surfaces and/or form a labyrinth seal in a simple structural manner by forming one or more rings on the ice-removal tool.

It is very particularly advantageous if at least one annular recess is surrounded by the toothed ring, the at least one annular recess being arranged or formed on the holder on the second side. The at least one annular recess, which in particular is annular, can be used to provide a running surface for a mating element of a thrust bearing. This results in the ice-removal tool being supported easily and securely on the ice-removal machine.

In particular, the at least one recess then forms a running surface (such as sliding surface or rolling surface) for a corresponding mating element of a thrust bearing of the ice-removal machine.

It is favorable if the holder is circular and has a central axis, which is, in particular, coaxial with the axis of rotation. This results in an effective ice-removal operation.

In one embodiment, a fixing device is arranged on the holder for fixing and in particular releasable fixing to the ice-removal machine. This makes it easy to exchange tools on the ice-removal machine.

In one embodiment, the fixing device has a connection piece with a through opening. By means of the connection piece, the ice-removal tool can be placed on a mating element and in particular a rotary bearing on the ice-removal machine.

In particular, the connection piece is arranged on the holder on the second side and protrudes therefrom. This makes it easy to provide a contact surface for a rotary bearing.

Expediently, at least one annular recess surrounds the connection piece. This allows a running surface for a thrust bearing to be provided.

In the opening of the at least one connection piece there is preferably at least one contact element, for example in the form of a contact ring for one or more mating elements of the ice-removal machine, in particular for the axial fixing of the ice-removal tool. In this way, the ice-removal tool can be easily held axially detachably on the ice-removal machine, for example in the form of a snap-fit locking means. A tool-free solution for an operator is thus possible, or rather an ice-removal tool can be fitted without tools on the ice-removal machine.

It is favorable if the ridges are produced from a plastics material and in particular if the holder is produced from a plastics material and in particular if the whole ice-removal tool is produced from a plastics material. By using a customized plastics material, on the one hand an effective ice removal can be achieved, for example on a vehicle window, and on the other hand damage to the vehicle window can be prevented.

The object mentioned at the outset is further achieved alternatively or additionally in that the ridges each have a first ridge side, a second ridge side and a third ridge side, wherein the first ridge side is oriented transversely to the first side of the holder and is connected thereto, the second ridge side is opposite the first ridge side, is oriented transversely to the first side of the holder and is connected thereto, and the third ridge side connects the first ridge side and the second ridge side to each other, and with at least one of the following:

the third ridge side is at an acute first angle in the range between 10° and 30° to a parallel of the first side of the holder;

the first ridge side is at an acute second angle to a normal of the first side of the holder.

It has been shown that with this formation of the ridges (teeth) an effective ice-removal operation is possible. The first angle to the parallel of the holder allows effective material removal during an ice-removal operation. The second angle also results in effective ice removal.

It is especially expedient if the second angle is smaller than the first angle.

In a preferred embodiment, the second angle is in the range between 3° and 7° and in particular in the range between 4° and 6° and in particular is about 5°. It has been shown that an effective ice-removal operation can be achieved in this way.

It can be expedient if the first ridge side is oriented at right angles to the first side of the holder.

It is favorable if the first ridge side follows a first path with respect to a certain height above the first side of the holder and the second ridge side follows a second path with respect to this certain height, the first path and the second path being oriented parallel to each other. This results in a relatively simple construction of the ridges with effective ice removal.

In particular, the ridges are configured and arranged in a scoop shape.

In an embodiment, the first path and/or the second path are curved and in particular have a constant curvature. The first path and the second path then follow a circular line.

It has proven to be favorable if a radius of curvature of the first path and/or the second path is greater than or equal to a radius of the holder. This results in an effective ice-removal effect.

It has also been shown that it is advantageous if an (imaginary) extension of the ridges meets a central axis of the holder. In this way, the ridges start so to speak from this central axis of the holder.

It can be provided that the ridges start from a connection piece or an opening and in particular are connected to the connection piece or border directly on the opening, or end at a spacing from the connection piece.

It is very particularly advantageous if the ridges are evenly distributed on the holder, i.e. adjacent ridges have the same angular spacing from each other. This results in an effective ice-removal effect.

It is favorable if the spacing between adjacent ridges increases towards an edge of the holder. This results in an effective ice-removal effect.

It has proven to be favorable if the number of ridges is between (inclusive) four and (inclusive) eight. In one embodiment, the number of ridges is six.

It is favorable if a direction of rotation during operation is oriented from the second ridge side to the first ridge side. This results in an effective ice-removal effect by means of the first ridge side and the subsequent third ridge side. Furthermore, material dislodged by means of the first acute angle can be effectively removed.

In accordance with the invention, a hand-held ice-removal machine is provided which comprises a drive motor to which an ice-removal tool according to the invention is torque-transmittingly connected.

The hand-held ice-removal machine has the advantages already explained in conjunction with the ice-removal tool according to the invention.

In particular, the ice-removal machine can be made compact, so that it can be held for operation in particular by just one hand.

In particular, it is provided that, during operation, the axis of rotation of the ice-removal tool is oriented transversely and in particular at least approximately perpendicularly to a working surface such as a vehicle window.

It is favorable if a gear unit is provided which is coupled torque-transmittingly to the drive motor. This allows, in particular, a relatively high speed of the drive motor to be reduced to an effective speed for ice removal, such as approximately 850 revolutions per minute.

It is very particularly advantageous if the gear unit is configured as an epicyclic gearing and has at least one rotating gear, which is coupled torque-transmittingly to a toothed ring with inner toothing of the ice-removal tool. An epicyclic gearing can be configured with relatively small height dimensions. This, in turn, allows the hand-held ice-removal machine to be configured with a low height. This machine can be configured compactly. This in turn makes it easy to hold and operate. In particular, the ice-removal tool is then configured as a ring gear, with the at least one rotating gear engaging in a corresponding toothed ring having an inner toothing.

It may be provided that the at least one rotating gear is rotatably mounted by a plain bearing and in particular the plain bearing comprises at least two separate sliding surfaces or sliding surface and mating sliding surface combinations. This results in a high bearing stability.

It is particularly advantageous if a housing is provided with an insertion region for a toothed ring of the ice-removal tool. This results in a compact construction. The hand-held ice-removal machine can be configured with relatively small height dimensions. This allows it to be held ergonomically. Furthermore, it can be stored in a small space.

It is particularly advantageous if the housing has at least one annular insertion region for an associated ring of the ice-removal tool, which surrounds the associated toothed ring of the ice-removal tool, in particular to form a labyrinth seal. This makes it possible to easily achieve a type of labyrinth seal by interaction of the ice-removal tool with the insertion region, by which the penetration of fluids into the housing can be prevented or reduced.

It is also advantageous if the housing has a receiving region for the holder of the ice-removal tool. This results in a construction with low height dimensions. In particular, the ice-removal machine can then be stored in a simple and space-saving manner. Furthermore, no moving parts protrude or project laterally.

It has proven to be advantageous if, with the ice-removal tool positioned, the holder is substantially in the receiving region and only the ridges protrude beyond an envelope plane of a housing. This results in a compact construction with easy handling and storage as well as high safety.

It is favorable if a housing has at least one holding region for an operator's hand, in particular with opposite housing sides being configured as holding regions. This allows the number of components for the hand-held ice-removal machine to be kept low. The existing housing, which is provided anyway, is then also used as a handle. The ice-removal machine can be easily operated and held by opposite sides of the housing.

It is very particularly advantageous if a push switch device for operating the drive motor is arranged on the housing and can be operated by a holding hand. In this way, a rotation of the ice-removal tool can be easily implemented by operating the push switch device.

In particular, a return spring device is associated with the push switch device, so that operation is only possible when the push switch device is actively pressed.

It has been shown to be favorable if the push switch device is positioned between opposite holding regions, such that, when the ice-removal machine is held at holding regions, the push switch device can be operated with the palm of the hand. This makes it easy to hold and operate the ice-removal machine.

In particular, the ice-removal machine is then configured to be held with a single hand. This results in a simple compact construction with easy handling.

It is favorable if a main switch is provided for a rotary drive of the ice-removal tool. Only if the main switch is turned on can a rotary drive actually be provided. In this case it is also preferable that a push switch device must be pressed while the main switch is on in order to implement a rotary drive. The main switch, when switched off, prevents unintended operation. This in turn makes it easy to store the ice-removal machine.

It is favorable if, in particular, a rechargeable battery device is provided. This makes it easy to provide a portable device that is self-sufficient when the battery device is charged.

In one embodiment a USB port is provided for charging the battery device. This results in a universal usability.

In an embodiment, a thrust bearing is provided for rotatably supporting the ice-removal tool and in particular a radial bearing and the thrust bearing are provided for rotatably supporting the ice-removal tool. This results in a secure support arrangement.

The following description of preferred embodiments serves in conjunction with the drawings to explain the invention in greater detail.

### BRIEF DESCRIPTION OF THE DRAWINGS

FIG. 1 shows a side view of an embodiment of a hand-held ice-removal machine according to the invention;

FIG. 2 shows a further side view of the ice-removal machine in direction A according to FIG. 1;

FIG. 3 shows a sectional view along line 3-3 according to FIG. 2;

FIG. 4 shows a bottom view of the ice-removal machine as shown in FIG. 1 in the direction B without ice-removal tool;

FIG. 5 shows a top view of a first side of an embodiment of an ice-removal tool according to the invention, showing an operative side (this view corresponds to the direction B according to FIG. 1);

FIG. 6 shows a sectional view along the line 6-6 according to FIG. 5;

FIG. 7 shows an isometric view of the ice-removal tool according to FIG. 5; and

FIG. 8 shows an enlarged view of the region C according to FIG. 3.

### DETAILED DESCRIPTION OF THE INVENTION

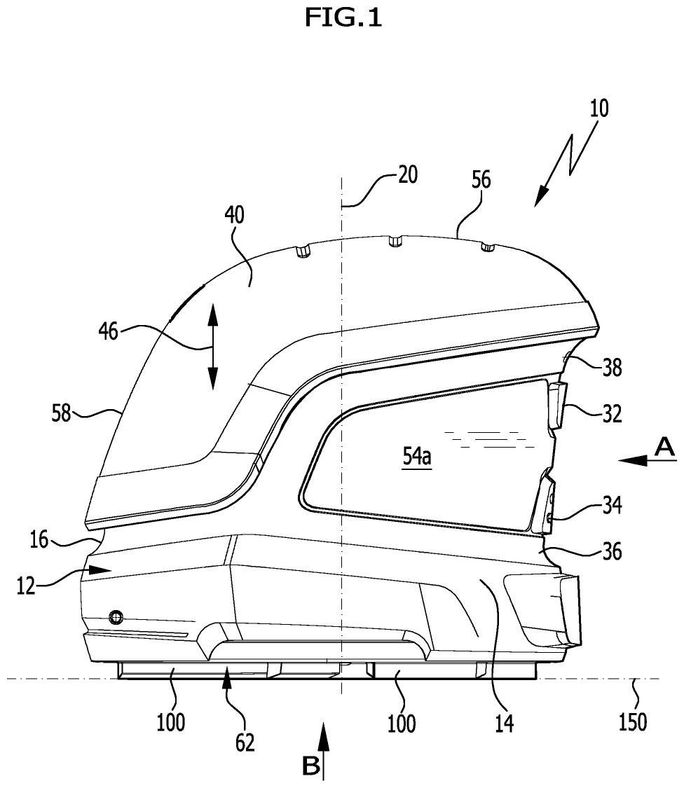

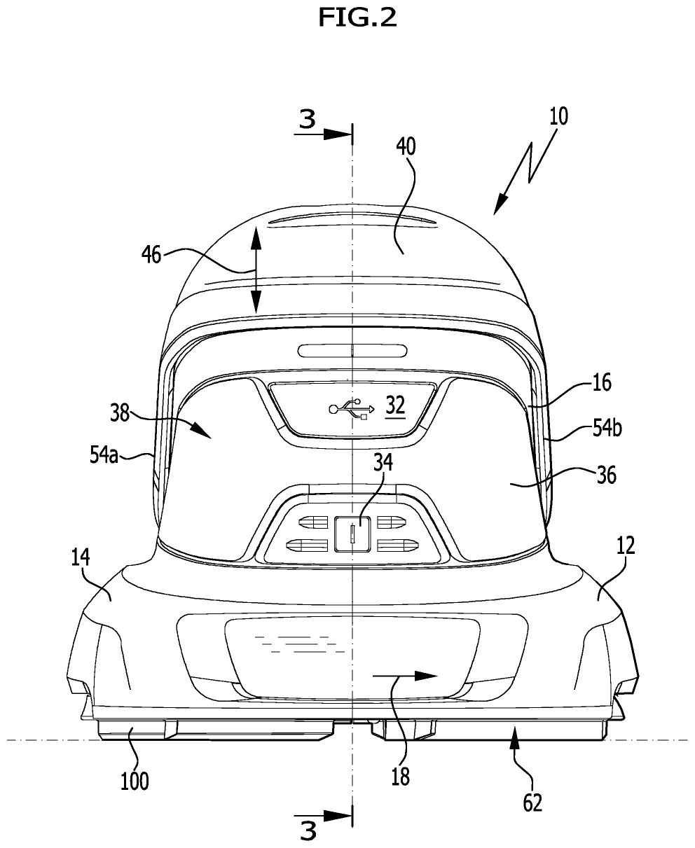

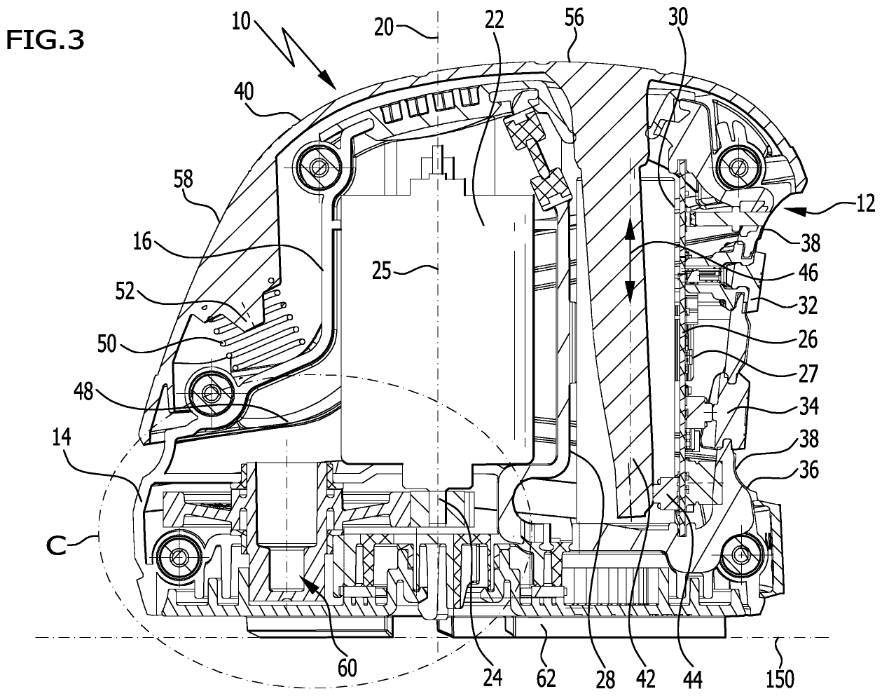

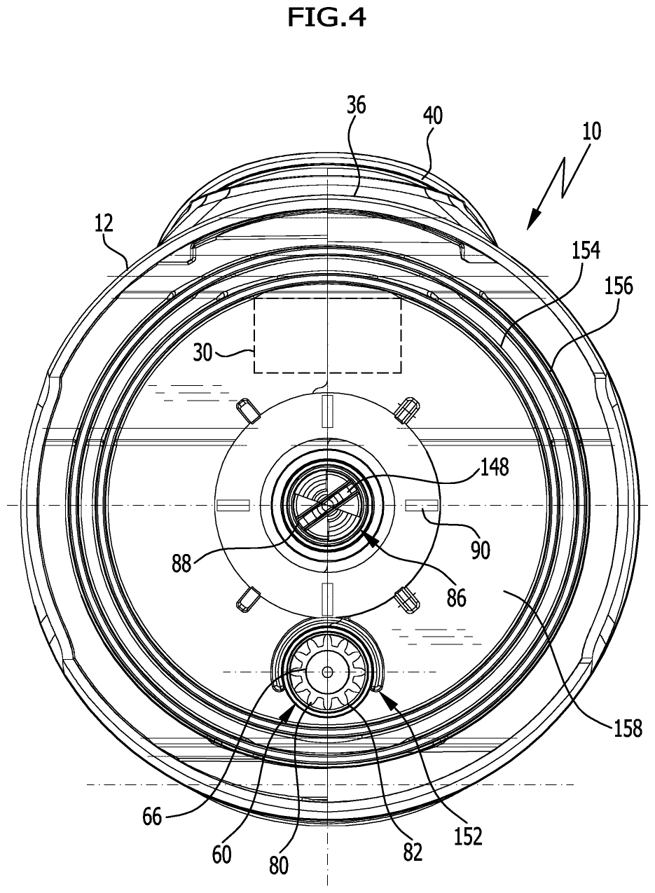

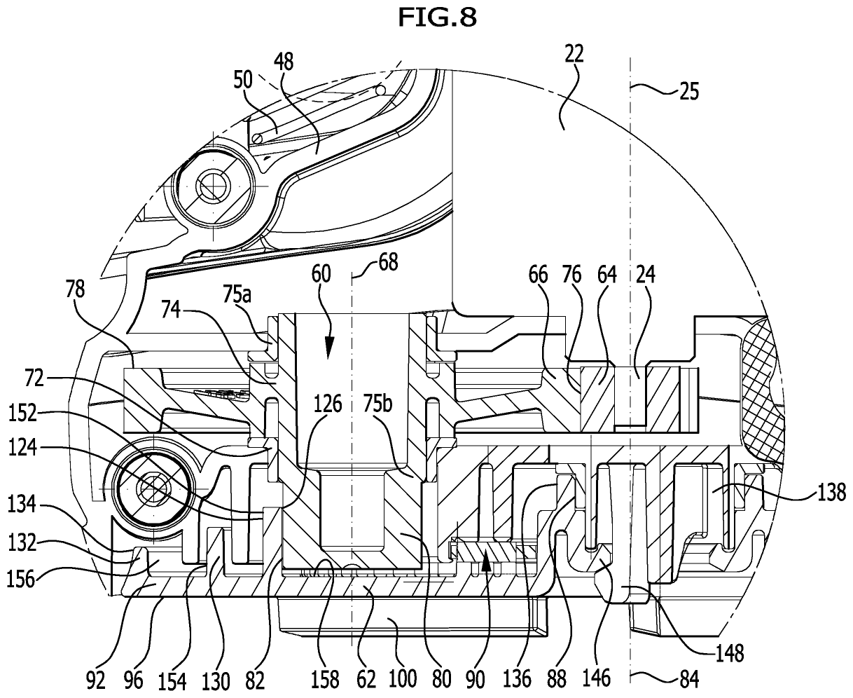

An embodiment of a hand-held ice-removal machine 10 according to the invention (FIGS. 1 to 4 and 8) is used in particular for mechanical ice scraping of vehicle windows.

The ice-removal machine 10 comprises a housing 12.

In an embodiment, the housing 12 has a first part 14, on which a second part 16 sits. Compared to the second part 16, the first part 12 is wider in a width direction 18.

The housing 12 with the first part 14 and the second part 16 extends in a height direction 20, which is oriented transversely to the width direction 18.

An electric motor 22 is arranged in the housing 12 and in particular in the second part 16 (or mostly in the second part 16). The electric motor 22 has a shaft 24 with a rotation axis 25, which is parallel to the height direction 20 and perpendicular to the width direction 18.

In the housing 12 there is arranged (at least) one circuit board 26, which carries a motor circuit 27.

In an embodiment, the circuit board 26 is positioned at a spacing from the electric motor 22 in the second part 16. It can project into the first part 14. In particular, it is oriented at least approximately parallel to the height direction 20.

In the housing 12 there is a gap 28 between the electric motor 22 and the circuit board 26. A rechargeable battery device 30 is also arranged in the housing 12.

On the housing 12 and in particular on the second part 16 there is a port 32 and in particular a USB port. This is electrically effectively connected to the battery device 30. The rechargeable battery device 30 can be charged by means of an electrical energy supply at the port 32. In particular, the battery device 30 can be charged via a USB connection. On the housing 12 and in particular on the second part 16 there is a main switch 34, which is electrically connected to the motor circuit 27. Only if the main switch 34 is set to “On”, with this “On” position being a fixed position, can the electric motor 22 be operated with rotation of the shaft 24. Accordingly, the main switch 34 has the “On” position and an “Off” position.

In an embodiment, the main switch 34 is positioned below the port 32 on one housing side 36 with respect to the height direction 20.

In one embodiment, the housing 12 has a recess 38 on the housing side 36, with the port 32 and the main switch 34 being arranged in the recess.

A push switch device 40 is mounted movably on the housing 12. The push switch device 40 substantially covers the first part 14 of the housing 12 in the height direction 20 upwardly and to the front. A pin 42 sits on the push switch device 40 and extends into the gap 28.

A contact element 44 is arranged on the circuit board 26 and interacts with the pin 42. Depending on the position of the pin 42 (determined by the position of the push switch device 40), there either is or is not a release for the drive of the shaft 24 by the electric motor 22.

The push switch device 40 is arranged movably on the housing 12 such that the push switch device is movable in a direction 46. The direction 46 is at least approximately parallel to the height direction 20.

By pressing the push switch device 40 in the height direction 20 downwards, the contact element 44 can be acted upon accordingly in such a way that a switching signal for the operation of the electric motor 22 is initiated.

However, the electric motor 22 with the shaft 24 is only put into operation if the main switch 34 is set to “On”. If the main switch 34 is set to “Off”, no position of the push switch device 44 can lead to initiation of the drive of the shaft 24.

A supporting surface 48 is formed on the housing 12 at a spacing from the gap 28. A return spring device 50 is supported on this supporting surface. The return spring device 50 acts on the push switch device 40. The push switch device 40 is provided with an insertion element 52, on which the return spring device 50 is supported.

The return spring device 50 ensures that if no pressure is exerted downwards on the push switch device 40 in the height direction 20, the push switch device 40 is returned to its initial position. In the initial position, the pin 42 is positioned in relation to the contact element 44 in such a way that no actuation signals are initiated for operation of the electric motor 22. The hand-held ice-removal machine 10 is configured to be held with one operator hand.

In particular, the housing 12 itself is configured as a handle for an operator hand. For this purpose, the housing 12 comprises opposite holding regions 54a, 54b in one embodiment. These are positioned below the push switch device 40 with respect to the height direction 20. They are configured in such a way that they can be grasped by an operator's hand, with a palm in particular being placeable on the push switch device 40. This allows the palm of the hand to be used to press the push switch device 40, and if the main switch 34 is set to “On”, this pressure can be used to start the electric motor 22, which results in rotation of the shaft 24 about the rotation axis 25. In particular, the push switch device 40 is ergonomically designed so that a palm of the hand can be placed on it, while the hand as a whole is placeable over the push switch device 40. In particular, the push switch device 40 has a first region 56 and a second region 58, with the second region 58 being transverse to the first region 56 with a rounded transition. The second region 58 extends towards the second part 16.

In particular, the palm of the hand can then be placed on the first region 56 and fingers on the second region 58 during operation. For example, the thumb can be used to touch the holding region 54a and the little finger or ring finger can be used to touch the holding region 54b.

This results in ergonomically favorable handling.

A gear unit 60 is arranged in the housing 12. The gear unit 60 serves to transmit a torque of the electric motor 22 to an ice-removal tool 62.

The gear unit 60 is especially configured as an epicyclic gearing, for example in the form of a planetary gearing.

A first toothed ring 64 (drive pinion) is connected to the shaft 24 for conjoint rotation. The first toothed ring 64 rotates about the rotation axis 25.

In the embodiment of a planetary gear, the first toothed ring 64 is a sun gear.

The first toothed ring 64 is positioned in particular in the first part 14 of the housing 12.

Furthermore, a second toothed ring 66 (output pinion) is positioned in the housing 12 and in particular in the first part 14. The second toothed ring 66 is mounted rotatably about a rotation axis 68, which is offset parallel to the rotation axis 25.

In an embodiment, the second toothed ring 66 is rotatably mounted in the housing 12 by means of a plain bearing 72.

In an embodiment, the second toothed ring 66 has a first region 74. The first region 74 is coupled to the first toothed ring 64 torque-transmittingly. The first region 74, accordingly, has a first toothing 76 adapted to the first toothed ring 64. The first region 74 is mounted slidingly by means of a first sliding surface and mating sliding surface combination 75a of the sliding bearing 72. This first sliding surface and mating sliding surface combination is in particular configured in such a way that both radial support and axial support are provided.

A second region 80 is connected to the first region 74 for conjoint rotation by means of a second toothing 82. The second region 80 is supported by a second sliding surface and mating sliding surface combination 75b. The second sliding surface and mating sliding surface combination 75b is separated (spaced) from the first sliding surface and mating sliding surface combination 75a. The second sliding surface and mating sliding surface combination 75b is in particular configured in such a way that both radial support and axial support are provided.

By means of the second toothing 82, the second toothed ring 66 can be coupled torque-transmittingly to the ice-removal tool 62, as explained in greater detail below. The second region 80 of the second toothed ring 66 has a smaller diameter than the first region 74.

The first region 74 is additionally positioned in a storage space 78 of the housing 12 (in the first part 14), with a type of positively-locking positioning being achieved. An additional sliding support in the storage space 78 can be provided.

The second toothed ring 66 is an outer gear; in the embodiment of a planetary gearing, the second toothed ring 66 corresponds to a planet gear.

In particular, the ice-removal tool 62 is configured as a ring gear (see below), which is coupled to the outer gear 66.

In particular, a two-shaft operation with a stationary transmission is provided, in which the first toothed ring 64 (the sun gear) and accordingly the ring gear (the ice-removal tool 62) rotate and a carrier shaft is stationary. This is achieved by a fixed connection to the housing 12.

In an embodiment, an axis of rotation 84 of the ice-removal tool 62 is coaxial with the axis of rotation 25 of the shaft 24 of the electric motor 22. In principle, however, there may also be a parallel offset.

In the housing 12, and in particular on the first part 14, there is a rotary bearing 86 for the ice-removal tool 62. The rotary bearing 86 comprises in particular a radial bearing 88 and a thrust bearing 90.

This is explained in greater detail below.

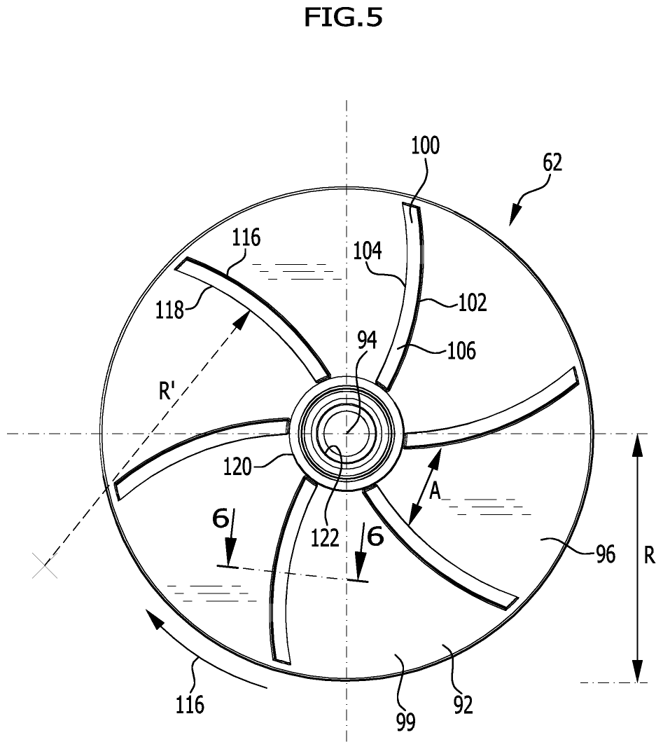

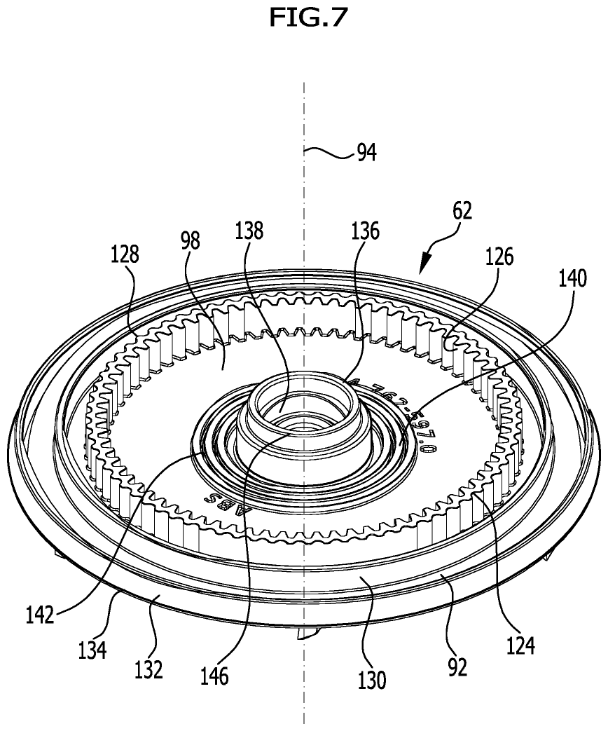

The ice-removal tool (FIGS. 5 to 7) is configured as a disc. It comprises a disc-shaped holder 92 with a central axis 94 (FIG. 7). The holder 92 has a first side 96 and a second side 98 opposite the first side. In particular, the spacing between the first side 96 and the second side 98 is constant. Preferably, the first side 96 and the second side 98 are substantially flat.

An outer contour 99 of the disc-shaped holder 92 is preferably a circle with a center on the central axis 94.

On the first side 96 a plurality of ridges 100 are formed. One such ridge 100 forms a serration for ice removal; a ridge 100 forms an ice scraper.

In particular, a plurality of ridges 100 are provided, which are preferably evenly spaced.

In the embodiment shown, six equally spaced ridges 100 are provided.

In particular, ridges 100 are provided with a number in the range between four (inclusive) and eight (inclusive).

The ridges 100 are arranged on the first side 96 and project over this in a direction parallel to the central axis 94.

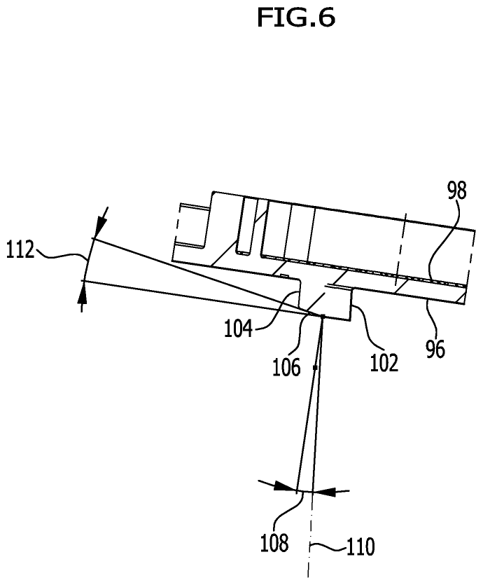

The ridges 100 each have a first ridge side 102, a second ridge side 104 and a third ridge side 106 (see also FIG. 6).

A ridge 100 is connected to the first side via the first ridge side 102. The first ridge side 102 is oriented transversely to the first side 96.

In particular, the first ridge side 102 is oriented at an acute second angle 108 to a normal 110 of the first side 96 of the holder 92.

The second ridge side 104 is opposite the first ridge side 102. It is oriented transversely and in particular perpendicularly to the first side 96 (i.e. parallel to the normal 110).

The third ridge side 106 connects the first ridge side 102 and the second ridge side 104. It is spaced from the first side 96 of the holder 92.

The third ridge side 106 is oriented at an acute first angle 112 to a parallel of the first side 96, i.e. correspondingly to the first side 96.

The first angle 112 is in particular in the range between (inclusive) 10° and (inclusive) 30°. The second angle 108 is in particular smaller than the first angle. It is preferably finite and is in particular in the range between (inclusive) 3° and (inclusive) 7° and preferably in the range between (inclusive) 4° and (inclusive) 6°. In one embodiment it is about 5°.

During operation, a direction of rotation 116 is in the direction from the second ridge side 104 to the first ridge side 102. This means that a certain region on an object is contacted first by the first ridge side 102.

The third ridge side 106 forms an inclined plane on a ridge 100. The corresponding inclination with the first angle 112 facilitates material removal (ice removal) at the ridges 100.

The ridges 100 are curved. In particular, the first ridge side 102 and the second ridge side 104 are curved.

A first path 116 of a ridge 100 on the first ridge side 102 at a certain height and a second path 118 on the second ridge side 104 at the same height are curved. These paths 116, 118 are in particular parallel to each other and follow the longitudinal course of the ridge 100 in question.

In particular, the curvature of the first path 116 and of the second path 118 is constant, that is to say they are sections of a circular path.

There is provided a radius of curvature R′, which is constant.

In particular, the radius of curvature R′ is equal to or greater than a radius R of the ice-removal tool 62, i.e. the disc-shaped holder 92.

Furthermore, it is preferably provided that the ridges 100 pass through the central axis 94 in an (imaginary) extension, that is to say an imaginary extension of a ridge intersects the central axis 94.

A spacing A between adjacent ridges 100 increases from the central axis 94 in a radial direction outwards.

In particular, the ridges 100 start from a connection piece 120 or a central opening 122, especially at a spacing. The connection piece 120, if provided, has a smaller height than the ridges 100.

On the second side 98 of the disc-shaped holder 92 (FIG. 7), there is arranged a toothed ring 124 with a central axis 94. This toothed ring 124 has an inner toothing 126. The toothed ring 124 forms a hollow ring so as to form a ring gear for the epicyclic gearing. The second toothed ring is coupled with its second region 80 (the outer gear) to the inner toothing 126.

In the embodiment shown, the toothed ring 124 also has an outer toothing 128. The outer toothing 128 has no coupling function and serves fundamentally to reinforce (stiffen) the toothed ring 124.

On the second side 98 of the disc-shaped holder 92 there sits a first ring 130, which surrounds the toothed ring 124, with the central axis 94 as its axis.

Furthermore, a second ring 132 sits on the second side 98 at a spacing from the first ring 130 and surrounds the first ring 130.

The first ring 130 and the second ring 132 protrude beyond the second side 98.

The second ring 132 forms a raised edge 134 of the ice-removal tool 62.

In particular, it is provided that the toothed ring 124 is connected integrally to the holder 92. Furthermore, it is expediently provided that the first ring 130 and the second ring 132 are connected integrally to the holder 92.

It may also be provided that the ridges 100 are connected integrally to the holder.

In an alternative embodiment, the ridges 100 are elements separate from the holder 92 and are subsequently fixed to the holder 92, for example by means of T-slots.

In particular, it is provided here that the first ring 130 has a lower height above the second side 98 than the toothed ring 124, and the second ring 132 has a lower height above the second side 98 of the holder 92 than the first ring 130.

A labyrinth seal is formed by means of the first ring 130 and the second ring 132, as explained in greater detail further below.

However, it is also possible in principle, alternatively or additionally, that an additional plain bearing of the ice-removal tool 62 on the ice-removal machine 10 is formed by means of the first ring 130 and/or the second ring 132.

In principle, regions on the second side 98 between the first ring 130 and the toothed ring 124 or between the second ring 132 and the first ring 130 can also be used as sliding surfaces.

On the second side 98 of the disc-shaped holder 92 there is a connection piece 136, which protrudes from the holder. The connection piece 136 has a central opening 138. This is, in particular, symmetrical with respect to the central axis 94.

The central opening 138 is connected to the central opening 122.

The connection piece 136 continues in particular at the connection piece 120, if provided.

The ice-removal tool 62 can be coupled to the rotary bearing 86 in the housing 12 by means of the connection piece 136.

In particular, the connection piece 136 is configured in such a way that radial support can be achieved by means of the radial bearing 88.

The connection piece 136 is surrounded by a plurality of annular recesses 140 (with the central axis 94 as the axis), which are in the form of grooves and are arranged or formed on the second side 98 of the disc-shaped holder 92.

The recesses 140 form running surfaces 142 as, for example, sliding surfaces or rolling surfaces for mating elements 144 of the thrust bearing 90 when the ice-removal tool 62 is mounted on the ice-removal machine 10.

The mating elements 144 are in particular needle elements, which then engage in the recesses 140.

This construction makes it possible to define an axial position of the ice-removal tool 62 in relation to the housing 12.

At least one contact element 146 is arranged on the connection piece 136, projecting into the central opening 138. In particular, the contact element 146 is a contact ring.

One or more mating elements 148 are arranged on the housing 12 and can be fitted with positive engagement on the contact element 146.

The mating elements 148 are configured in the manner of a snap-fit locking means.

By positioning them appropriately in the central opening 138, they do not touch the contact element 146, and the ice-removal tool 62 can be removed.

In a basic position, they are in contact with the contact element 146 and an axial fixing is achieved.

The ice-removal tool 82 can be easily fitted and detached without tools due to the construction with contact element 146 and mating element 148 (or mating elements 148).

The ridges 100 and in particular only the ridges 100 protrude beyond an envelope plane 150 of the housing 12. This results in a compact construction.

In particular, the housing 12 has an insertion region 152 for the toothed ring 124 on the first part 14. When the ice-removal tool 62 is fixed, the toothed ring 124 is completely inside the housing 12, i.e. behind the envelope plane 150.

The housing 12 also has a first annular insertion region 154 for the first ring 130 of the ice-removal tool 62, and a second annular insertion region 156 for the second ring 132. These annular insertion regions 154, 156 are in the form of grooves and are separated from each other.

When the ice-removal tool 62 is held on the rotary bearing 86 and the second toothed ring 66 engages with the toothed ring 124, more specifically its inner toothing 126, and the corresponding position is secured by the mating element 148, the combination of the rings 130, 132 with their insertion regions 154, 156 forms a labyrinth seal that prevents water from entering a housing interior.

Furthermore, the housing 12 has a receiving region 158 for the holder 92 on the first part 14. In particular, the receiving region 158 is configured in such a way that when the ice-removal tool 62 is fixed, the first side 96 of the holder 92 is at least approximately in the envelope plane 150.

In this case only the ridges 108 protrude outwardly.

This results in a compact construction with respect to a height in the height direction 20. This in turn results in a simple ergonomic operation.

The ice-removal machine 10 according to the invention functions as follows:

For the operation of the ice-removal machine 10, the ice-removal tool 62 is rotatably mounted on the rotary bearing 86 and fixed in place.

The battery device 30 is charged. By actuating the main switch 34, the ice-removal machine 10 is put into operation.

By pressing the push switch device 40 the shaft 24 rotates.

The ice-removal tool 62 has a rotation axis 84, which is at least approximately parallel to the height axis 20.

For correct operation, this rotation axis 84 is oriented transversely to a working surface.

For example, the working surface is an ice surface on a car window.

An operator holds the ice-removal machine 10 at the housing 12 and in particular at the holding regions 54a, 54b and can apply pressure to the push switch device 40 by means of the palm of his hand.

When the main switch 34 is switched on, pressing the push switch device 40 causes the electric motor 22 to operate with rotation of the shaft 24.

In an embodiment, a typical rotational speed is approximately 11,000 revolutions per minute.

The gear unit reduces the speed to, for example, 850 revolutions per minute of the ice-removal tool 62 about the rotation axis 84.

The gear unit 60 is configured in particular as an epicyclic gearing. This results in a compact axial construction (in the direction of height 20) and the ice-removal machine 10 can be configured with a low height. This in turn results in simple and ergonomic handling.

The (in particular only) outer gear 66 transmits the torque to the toothed ring 124. It thus forms a ring gear with the disc-shaped holder 92.

The ridges 100 on the ice-removal tool 62 are configured with the acute angles 112, 108 and the curvature and in particular are configured in the manner of a paddle wheel to provide optimized ice removal. It is thus possible to remove ice from a vehicle window in particular within a relatively short time.

The ridges 100 and preferably also the disc-shaped holder 92 and particularly preferably the entire ice-removal tool 62 is made of a plastics material which on the one hand enables effective ice removal and on the other hand prevents damage, in particular to glass surfaces. An example of such a plastics material is ABS (acrylonitrile-butadiene-styrene copolymers) as an example of a thermoplastic terpolymer.

It has been shown that with the described construction of the ridges 100 an effective ice removal can be carried out.

The ice-removal tool 62 can be easily replaced.

By adapting the construction of the annular insertion regions 154, 156 and the rings 130, 132, a labyrinth seal can be easily formed to prevent fluids from entering the housing 12. In addition, it provides a simple coding so that only correct ice-removal tools 62 can be used with the ice-removal machine 10.

The ice-removal machine 10 can also be used with other adapted tools, such as those used to clean vehicle windows.

### LIST OF REFERENCE NUMERALS

10 ice-removal machine
12 housing
14 first part
16 second part
18 width direction
20 height direction
22 electric motor
24 shaft
25 axis of rotation
26 circuit board
27 motor circuit
28 gap
30 battery device
32 port
34 main switch
36 housing side
38 recess
40 push switch device
42 pin
44 contact element
46 direction
48 supporting surface
50 return spring device
52 insertion element
54a holding region
54b holding region
56 first region
58 second region
60 gear unit
62 ice-removal tool
64 first toothed wheel
66 second toothed wheel
68 axis of rotation
72 plain bearing
74 first region
75a first sliding surface and mating sliding surface combination
75b second sliding surface and mating sliding surface combination
76 first toothing
78 storage space
80 second region
82 second toothing
84 axis of rotation
86 rotary bearing
88 radial bearing
90 thrust bearing
92 disc-shaped holder
94 central axis
96 first side
98 second side
99 outer contour
100 ridge
102 first ridge side
104 second ridge side
106 third ridge side
108 second angle
110 normal
112 first angle
114 direction of rotation
116 first path
118 second path
120 connection piece
122 central opening
124 toothed ring
126 inner toothing
128 outer toothing
130 first ring
132 second ring
134 edge
136 connection piece
138 central opening
140 recess
142 running surface
144 mating element
146 contact element
148 mating element
150 envelope plane
152 insertion region
154 first annular insertion region
156 second annular insertion region
158 receiving region

1. An ice-removal tool for an ice-removal machine, which tool, during operation, is driven in rotation about an axis of rotation, comprising
a disc-shaped holder with a first side and a second side, which is opposite the first side; and a plurality of ridges being arranged on the first side;
wherein a toothed ring with an inner toothing is arranged on the second side.

2. The ice-removal tool in accordance with claim 1, wherein at least one of the ridges and the toothed ring are integrally connected to the holder.

3. The ice-removal tool in accordance with claim 1, wherein a first ring is arranged on the second side, is spaced from the toothed ring, and surrounds the toothed ring, the first ring being integrally connected to the holder.

4. The ice-removal tool in accordance with claim 3, wherein the first ring has a smaller height above the holder than the toothed ring.

5. The ice-removal tool in accordance with claim 3, wherein a second ring is arranged on the second side, is spaced from the first ring, and surrounds the first ring, the second ring being integrally connected to the holder.

6. The ice-removal tool in accordance with claim 5, wherein the second ring has a lower height than at least one of the first ring and the toothed ring.

7. The ice-removal tool in accordance with claim 3, wherein the first ring or a second ring surrounding the first ring forms an edge on the holder.

8. The ice-removal tool in accordance with claim 3, wherein at least one of the following is the case:
at least one sliding surface is arranged on the first ring;
a region on the holder between the first ring and the toothed ring forms a sliding surface;
a second ring surrounding the first ring has at least one sliding surface;
a region between the second ring and the first ring forms a sliding surface;
at least one of the first ring and the second ring form a fluid seal or part of a fluid seal.

9. The ice-removal tool in accordance with claim 1, wherein at least one annular recess is surrounded by the toothed ring, the at least one annular recess being arranged or formed on the holder on the second side.

10. The ice-removal tool in accordance with claim 9, wherein the at least one recess forms a running surface for a thrust bearing.

11. The ice-removal tool in accordance with claim 1, wherein the holder is circular and has a central axis, which is coaxial with the axis of rotation.

12. The ice-removal tool in accordance with claim 1, wherein a fixing device is arranged on the holder for fixing and releasable fixing to the ice-removal machine.

13. The ice-removal tool in accordance with claim 12, wherein the fixing device has a connection piece with a through opening.

14. The ice-removal tool in accordance with claim 13, wherein the connection piece is arranged on the holder on the second side and protrudes therefrom.

15. The ice-removal tool in accordance with claim 13, wherein at least one annular recess surrounds the connection piece.

16. The ice-removal tool in accordance with claim 13, wherein in the opening there is arranged at least one contact element for one or more mating elements of the ice-removal machine for the axial fixing of the ice-removal tool.

17. The ice-removal tool in accordance with claim 1, wherein the ridges are produced from a plastics material and the holder is produced from a plastics material and the whole ice-removal tool is produced from a plastics material.

18. The ice-removal tool in accordance with claim 1, wherein the ridges each have a first ridge side, a second ridge side and a third ridge side, the first ridge side being oriented transversely to the first side of the holder and connected thereto, the second ridge side being opposite the first ridge side, oriented transversely to the first side of the holder and connected thereto, and the third ridge side connecting the first ridge side and the second ridge side to each other, with at least one of the following:
the third ridge side is at an acute first angle in the range between 10° and 30° to a parallel of the first side of the holder;
the first ridge side is at an acute second angle to a normal of the first side of the holder.

19. The ice-removal tool in accordance with claim 18, wherein the second angle is smaller than the first angle.

20. The ice-removal tool in accordance with claim 18, wherein the second angle is in the range between 3° and 7°.

21. The ice-removal tool in accordance with claim 18, wherein the first ridge side is oriented at right angles to the first side of the holder.

22. The ice-removal tool in accordance with claim 18, wherein the first ridge side follows a first path with respect to a certain height above the first side of the holder and the second ridge side follows a second path with respect to this certain height, the first path and the second path being oriented parallel to one another.

23. The ice-removal tool in accordance with claim 22, wherein at least one of the first path and the second path are curved and have a constant curvature.

24. The ice-removal tool in accordance with claim 23, wherein a radius of curvature (R′) of at least one of the first path and the second path is greater than or equal to a radius (R) of the holder.

25. The ice-removal tool in accordance with claim 18, wherein an extension of the ridges meets a central axis of the holder.

26. The ice-removal tool in accordance with claim 18, wherein the ridges start from a connection piece or an opening and are connected to the connection piece or are spaced therefrom.

27. The ice-removal tool in accordance with claim 18, wherein the ridges are evenly distributed on the holder.

28. The ice-removal tool in accordance with claim 18, wherein a spacing (A) between adjacent ridges increases towards an edge of the holder.

29. The ice-removal tool in accordance with claim 18, wherein the number of ridges is between four and eight.

30. The ice-removal tool in accordance with claim 18, wherein a direction of rotation during operation is oriented from the second ridge side to the first ridge side.

31. A hand-held ice-removal machine comprising
a drive motor to which an ice-removal tool is torque-transmittingly connected,
said ice-removal tool comprising:
a disc-shaped holder with a first side and a second side, which is opposite the first side; and a plurality of ridges being arranged on the first side;
wherein a toothed ring with an inner toothing is arranged on the second side.

32. The hand-held ice-removal machine in accordance with claim 31, having a gear unit which is torque-transmittingly coupled to the drive motor.

33. The hand-held ice-removal machine in accordance with claim 32, wherein the gear unit is configured as an epicyclic gearing and has at least one rotating gear, which is coupled torque-transmittingly to a toothed ring with inner toothing of the ice-removal tool.

34. The hand-held ice-removal machine in accordance with claim 33, wherein the at least one rotating gear is rotatably mounted by a plain bearing and the plain bearing comprises at least two separate sliding surfaces.

35. The hand-held ice-removal machine in accordance with claim 31, having a housing with an insertion region for a toothed ring of the ice-removal tool.

36. The hand-held ice-removal machine in accordance with claim 35, wherein the housing has at least one annular insertion region for an associated ring of the ice-removal tool, which surrounds the associated toothed ring of the ice-removal tool to form a labyrinth seal.

37. The hand-held ice-removal machine in accordance with claim 35, wherein the housing has a receiving region for the holder of the ice-removal tool.

38. The hand-held ice-removal machine in accordance with claim 37, wherein, with the ice-removal tool positioned, the holder is substantially in the receiving region and only the ridges protrude beyond an envelope plane of a housing.

39. The hand-held ice-removal machine in accordance with claim 31, wherein a housing has at least one holding region for an operator's hand, with opposite housing sides being configured as holding regions.

40. The hand-held ice-removal machine in accordance with claim 39, wherein a push switch device for operating the drive motor is arranged on the housing and is operable by a holding hand.

41. The hand-held ice-removal machine in accordance with claim 40, wherein a return spring device is associated with the push switch device.

42. The hand-held ice-removal machine in accordance with claim 40, wherein the push switch device is positioned between opposite holding regions, whereby when the ice-removal machine is held at the holding regions, the push switch device is operable with a palm of the hand.

43. The hand-held ice-removal machine in accordance with claim 31, having a construction for holding with a single hand.

44. The hand-held ice-removal machine in accordance with claim 31, having a main switch for a rotary drive of the ice-removal tool.

45. The hand-held ice-removal machine in accordance with claim 31, having a battery device.

46. The handheld ice-removal machine in accordance with claim 45, having a USB port for charging the battery device.

47. The hand-held ice-removal machine in accordance with claim 31, having a thrust bearing for rotatably supporting the ice-removal tool and by a radial bearing and the thrust bearing for rotatably supporting the ice-removal tool.
